(19) United States
(12) Patent Application Publication
(10) Pub. No.: US 2026/0319924 A1
(43) Pub. Date: Oct. 15, 2026

(54) INTELLIGENT DEFECT DETECTION IN FUNCTIONAL DOCUMENTS

(71) Applicant: INTERNATIONAL BUSINESS MACHINES CORPORATION, Armonk, NY (US)

(72) Inventors: Yan Yan Han, Xi'an (CN); Yue Yang, Beijing (CN); Ling Zhuo, Beijing (CN); Pei Pei Liang, Beijing (CN); Yuan Feng, Beijing (CN); QI MIN, Beijing (CN); Fei Fan, XIAN (CN); VAISHNAVI RAMAPRIYA, San Jose, CA (US)

(21) Appl. No.: 19/178,121

(22) Filed: Apr. 14, 2025

(51) Int. Cl. G06F 11/3668

(52) U.S. Cl. CPC G06F 11/3684; G06F 11/3692

(57) ABSTRACT

A method, system, and computer program product configured to perform operations including: generating a test case tree graph based on a combination of a functional requirement document and a test case document; generating a plurality of defects tree graphs based on a known defects document; responsive to determining that the test case tree graph does not meet a predetermined level of granularity, iteratively refining the test case tree graph until the predetermined level of granularity is met; generating a normalized test case; generating normalized defects cases; and generating recommendations to correct potential issues in the functional requirement document identified based on similarities between the normalized test case and one or more respective ones of the normalized defects cases.

### BACKGROUND

Aspects of the present invention relate generally to intelligent methods for detecting defects in functional documents.

Debugging functional documents and the code of functional documents often involves identifying, analyzing, and fixing errors or defects that affect an expected behavior in a computer program. Debugging may include using tools like debuggers, logging, and breakpoints to trace execution, inspect variables, and diagnose issues. Test cases in debugging are predefined conditions or scenarios used to verify whether a portion of the functional document behaves as expected. When a test case fails, it helps pinpoint issues in the document.

### SUMMARY

In a first aspect of the invention, there is a method including: generating a test case tree graph based on a combination of a functional requirement document and a test case document; generating a plurality of defects tree graphs based on a known defects document; responsive to determining that the test case tree graph does not meet a predetermined level of granularity, iteratively refining the function test case tree graph until the predetermined level of granularity is met; generating a normalized test case by translating branches of the test case tree graph to related portions of a test template, assigning labels to the normalized test case to describe the respective portions of the normalized test case, and assigning first weights to the respective portions of the normalized test case; generating normalized defects cases by translating branches of the defects tree graphs to related portions of the test template, assigning labels to the normalized defects cases to describe the respective portions of the normalized defects cases, and assigning second weights to the respective portions of the normalized test case; and generating recommendations to correct potential issues in the functional requirement document identified based on similarities between the normalized test case and at least one normalized defects case of the normalized defects cases.

In another aspect of the invention, there is a computer program product comprising one or more computer-readable storage media and program instructions stored on the one or more computer-readable storage media to perform operations comprising: generating a test case tree graph based on a combination of a functional requirement document and a test case document; generating a plurality of defects tree graphs based on a known defects document; responsive to determining that the test case tree graph does not meet a predetermined level of granularity, iteratively refining the function test case tree graph until the predetermined level of granularity is met; generating a normalized test case by translating branches of the test case tree graph to related portions of a test template, assigning labels to the normalized test case to describe the respective portions of the normalized test case, and assigning first weights to the respective portions of the normalized test case; generating normalized defects cases by translating branches of the defects tree graphs to related portions of the test template, assigning labels to the normalized defects cases to describe the respective portions of the normalized defects cases, and assigning second weights to the respective portions of the normalized test case; and generating recommendations to correct potential issues in the functional requirement document identified based on similarities between the normalized test case and at least one normalized defects case of the normalized defects cases.

In another aspect of the invention, there is a computer system comprising a processor set, one or more computer-readable storage media, and program instructions stored on the one or more computer-readable storage media to cause the processor set to perform operations comprising: generating a test case tree graph based on a combination of a functional requirement document and a test case document; generating a plurality of defects tree graphs based on a known defects document; responsive to determining that the test case tree graph does not meet a predetermined level of granularity, iteratively refining the function test case tree graph until the predetermined level of granularity is met; generating a normalized test case by translating branches of the test case tree graph to related portions of a test template, assigning labels to the normalized test case to describe the respective portions of the normalized test case, and assigning first weights to the respective portions of the normalized test case; generating normalized defects cases by translating branches of the defects tree graphs to related portions of the test template, assigning labels to the normalized defects cases to describe the respective portions of the normalized defects cases, and assigning second weights to the respective portions of the normalized test case; and generating recommendations to correct potential issues in the functional requirement document identified based on similarities between the normalized test case and at least one normalized defects case of the normalized defects cases.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A and 3B show a flowchart of an exemplary method in accordance with aspects of the present invention.

FIG. 4 shows a flowchart of an exemplary method in accordance with aspects of the present invention.

FIG. 5 shows a flowchart of an exemplary method in accordance with aspects of the present invention.

### DETAILED DESCRIPTION

Aspects of the present invention relate generally to generally to intelligent systems and methods for detecting defects in functional documents (i.e., operational documents). Specifically, aspects of the present invention provide systems and methods for ingesting, transforming, and normalizing functional requirements for a software system and/or product, test cases related to the functional requirements, and historical known defects. According to aspects of the invention, the systems and methods may compare the normalized functional requirements, test cases related to the functional requirements, and the historical known defects to identify issues, solutions, and recommendations, previously unknown and/or overlooked by developers, for improving the functional documents.

As software developers and programmers develop and implement new features for a software product, test cases are generally designed to ensure that a software product functions correctly, meets requirements, and/or maintains a level of quality. In some instances, test cases may be curated for specific end users based on the needs and requirements of the end user. However, some functional and/or performance scenarios may be overlooked while testing the software product during various stages of development. Such blind spots where test cases have not been developed and/or have been overlooked lead to undiscovered, and often serious, functional and/or performance issues. In such instances, developers and programmers often need large amounts of time to analyze, diagnose, and fix the functional and/or performance issues. These types of fixes are time consuming, expensive, and often require architectural overhauls and/or substantial revisions, which often create downstream changes to other portions of the software product. In the final stages of development modifications these types of changes can be catastrophic because they may disrupt existing functionality, require extensive retesting, and lead to cascading changes that affect dependent modules or integrated systems. Furthermore, each of these scenarios introduce significant risks, including system instability, unforeseen compatibility issues, increased development costs, and potential delays in product release. Therefore, known systems suffer from the problem of inadequate methods for generating test cases during software product development, leading to the foregoing risks and inefficiencies.

Implementations of the invention address this problem by providing a method, system, and computer program product that, as described above, identifies issues, solutions, and recommendations, previously unknown and/or overlooked by developers, for improving the functional documents. Specifically, aspects of the invention involve a series of data transformations that modify and normalize the data such that data originated from a variety of developers, styles, programs, etc., can be more easily compared and similarities between the data are discoverable. According to aspects of the invention, the systems and methods use the determined similarities to issues, solutions, workarounds, and recommendations to improve the functional documents as the document and source code related to the document develops, thereby avoiding the costly risks and inefficiencies of existing technologies. Accordingly, implementations of the invention improve the technology field of software quality assurance and defect detection by enabling automated identification of issues, solutions, and recommendations in functional documents.

According to an aspect of the present invention, the method, system, and computer program product include: performing a flowchart analysis for a test case and for a document comprising known defects; extracting and reconstructing steps of the flowchart for the test case and the flowchart for the document comprising known defects; and comparing the flowchart for the test case and the flowchart for the document comprising known defects to determine a level of accuracy (i.e., granularity) and/or a level of similarity by determining relationships between the flowcharts. This provides an improvement over existing technologies because it enables a structured and automated approach to defect detection by systematically analyzing relationships between test cases and known defects. By reconstructing and comparing flowcharts, the method ensures a higher level of accuracy and granularity, reducing ambiguity in defect identification. Additionally, leveraging flowchart analysis enhances the ability to detect patterns, similarities, and inconsistencies that might be overlooked in traditional manual or static code review methods. This results in improved software quality, faster debugging, and a more efficient defect resolution process.

In embodiments, determining the level of accuracy and/or the level of similarity comprises determining an overall document similarity score based on weighted similarity labels assigned to various steps within the flowcharts. This improves the precision and effectiveness of comparing operational documents by reducing errors, enhancing matching accuracy, and ensuring more reliable results. In embodiments, the weights assigned to the weighted similarity labels are determined and/or refined using a regression model trained on historical data and manual labels.

Implementations of the present invention are necessarily rooted in computer technology. For example, iteratively refining the function test case tree graph until the predetermined level of granularity is met and iteratively training a regression model to predict similarities between the normalized test case and at least one normalized defects case of the normalized defects are computer-based and cannot be performed in the human mind.

It should be understood that, to the extent implementations of the present invention collect, store, or employ personal information provided by, or obtained from, individuals (e.g., information captured when extracting data from functional documents and defect documents), such information may be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as novel defect detection code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

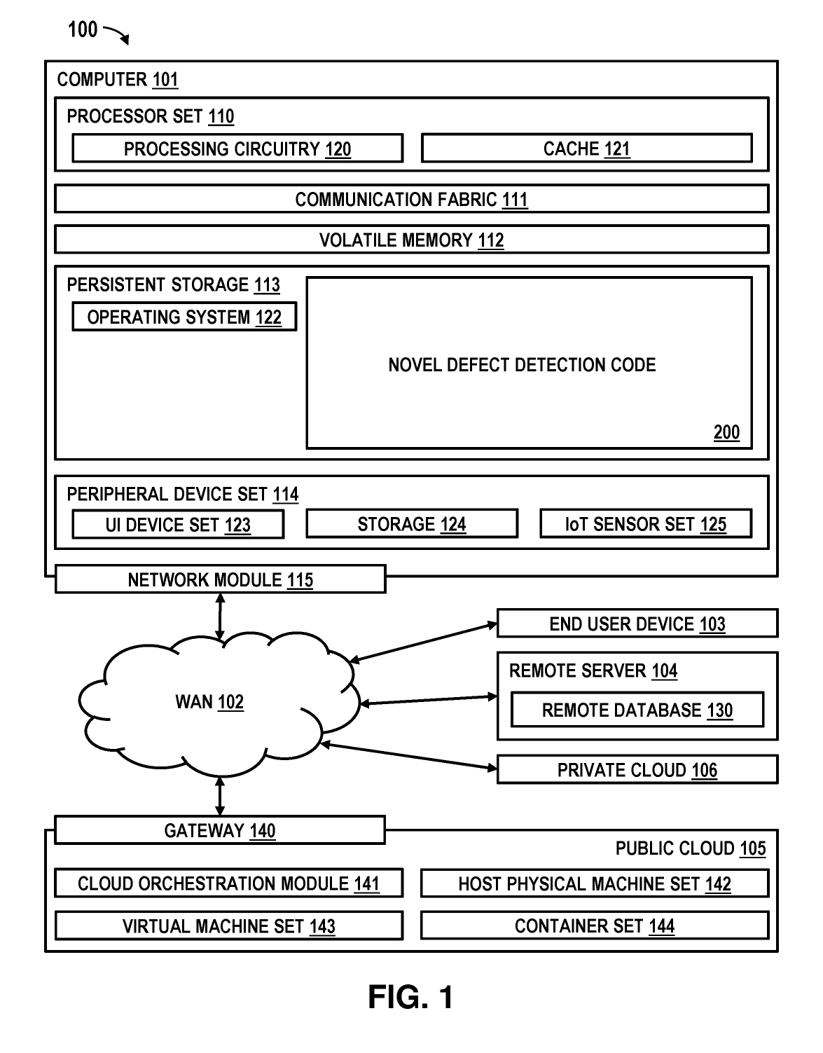

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

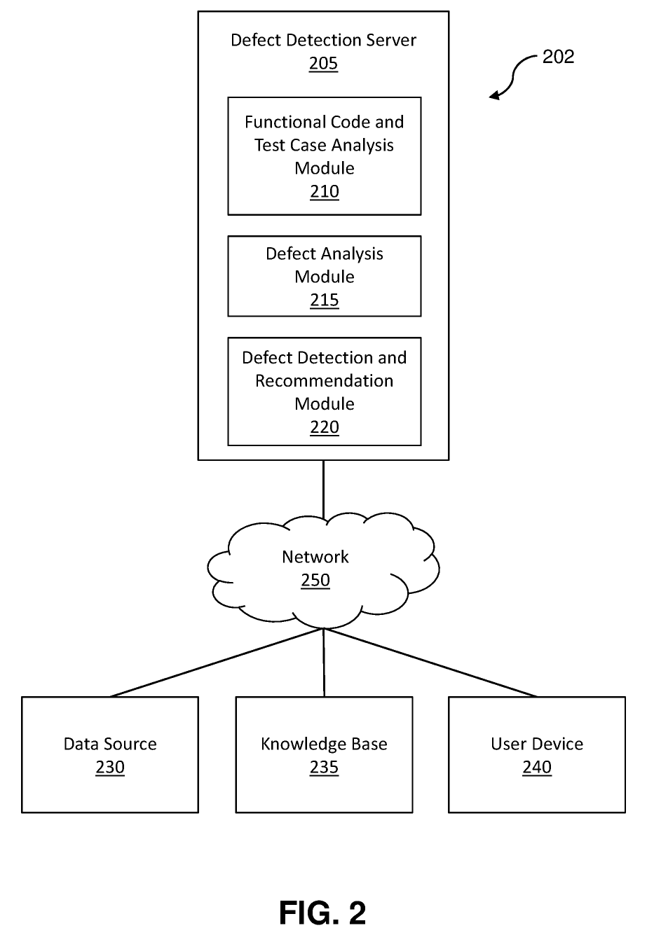

FIG. 2 shows a block diagram of exemplary environment 202 in accordance with aspects of the present invention. In embodiments, environment 202 includes defect detection server 205, data source 230, user device 240, and network 250.

Defect detection server 205 may comprise one or more instances of computer 101 of FIG. 1. In another example defect detection server 205 may comprise one or more virtual machines or containers running on one or more instances of computer 101 of FIG. 1. In embodiments, defect detection server 205 communicates with data source 230 and user device 240 via network 250, which may comprise WAN 102 of FIG. 1. In embodiments, data source 230 may comprise one or more data sources each comprising an instance of remote database 130 and/or remote server 104 of FIG. 1. In embodiments, user device 240 comprises an instance of EUD 103 of FIG. 1. There may be plural different instances of user device 240 including, for example, personal computing devices or any other device capable of using and rendering a dynamic shell history command. The different instances of user device 240 may be used by different users, programmers, evaluators, operators, technicians, etc.

In embodiments, defect detection server 205 of FIG. 2 comprises functional code and test case analysis module 210, defect analysis module 215, and defect detection and recommendation module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. defect detection server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, defect detection server 205 is configured to facilitate communication between functional code and test case analysis module 210, defect analysis module 215, defect detection and recommendation module 220, and external storage (e.g., data source 230 and/or knowledge base 235) and devices (e.g., user device 240) via network 250.

In embodiments, defect detection server 205 may be configured to receive, access, and/or obtain a functional requirement document for a software system and/or product. As used herein, a functional requirement document refers to a document that outlines the specific functions, features, and/or behaviors that a software system and/or product should have to meet the needs of a customer (e.g., user, entity, corporation, etc.). In embodiments, the functional requirement document may serve as a blueprint for developers, testers, and/or designers to understand what the system should do. In embodiments, the functional requirement document specifies what the system should do (e.g., allow users to login with a credential, allow users to search for products by category, support up to n number of concurrent users, etc.) and/or it specifies inputs, processes, actions, and/or expected outputs for each feature. In embodiments, the functional requirement document may be received, accessed, and/or obtained locally and/or from a data source (e.g., data source 230) over a network (e.g., network 250).

In embodiments, defect detection server 205 may be configured to receive, access, and/or obtain a test case document (e.g., a function test case document) related to the functional requirement document. As used herein, the test case document refers to a document that outlines the test cases designed to verify whether the functionalities specified in the functional requirement document are correctly implemented and working as expected. In embodiments, the test case document may comprise a test case identification, a test case description, preconditions (i.e., setup or conditions that must be met before executing the test), test steps (i.e., a step-by-step procedure to execute the test), expected results, actual results, pass/fail status (i.e., whether the test case passed or failed based on the comparison of expected vs. actual results), related functional requirements (i.e., a pointer and/or link back to the corresponding functional requirements), and/or other aspects for documenting and tracking test cases. In embodiments, the test case document may be received, accessed, and/or obtained locally and/or from a data source (e.g., data source 230) over a network (e.g., network 250).

In embodiments, defect detection server 205 may be configured to receive, access, and/or obtain an existing defects document related to the functional requirement document and/or the test case document. As used herein, the existing defects document refers to a repository and/or document that contains records of previously identified defects, bugs, and/or issues in a software system. In embodiments, the existing defects document serves as a knowledge base to track and analyze past problems, their causes, and/or their solutions. In embodiments, the existing defects document may include a defect identification, summary, description (i.e., detailed information about the defect, including how it was discovered and its impact on the system), steps to reproduce the defect, expected vs. actual results (i.e., what was expected to happen vs. what actually occurred), severity (e.g., critical, high, medium, low), status, resolution (i.e., an explanation for how the defect was resolved), solution (i.e., an explanation for how the defect was solved and/or a workaround), a product version, and/or any other aspect for documenting known defects. In embodiments, the test case document may be received, accessed, and/or obtained locally and/or from a knowledge base (e.g., knowledge base 235) over a network (e.g., network 250).

In accordance with aspects of the present invention, functional code and test case analysis module 210 may be configured to convert the functional requirement document and/or the test case document into at least one flowchart, respectively. In embodiments the functional requirement document and/or the test case document are converted into flowcharts by identifying specifications such as processes, user interactions, system behaviors, action sequences, decision points, and/or outputs. Based on the identified specifications, functional code and test case analysis module 210 may determine a sequence of actions which can be mapped into a start, inputs, processes, decisions, outputs, and end. For example, if the functional requirement document describes, for example, a user login process, the sequence of actions may include a start (e.g., a user initiates a login), inputs (e.g., a user enters a username and password), processes (e.g., the system verifies credentials), decisions (e.g., is the username and password, correct? Yes = proceed, No = error), outputs (e.g., the user is either logged in or receives an error message), and end (e.g., the session begins). In embodiments where the functional requirement document and/or test case document include multiple features, each feature may be converted into at least one flowchart. In embodiments, functional code and test case analysis module 210 may employ a natural language processing algorithm to extract text describing the processes, user interactions, system behaviors, action sequences, decision points, and/or outputs when converting the functional requirement document and/or the test case document into a flowchart. In embodiments, converting documents into flowcharts in this manner beneficially enhances clarity, ensures consistency in test case generation, simplifies defect identification, and facilitates automated analysis by structuring complex requirements into a standardized format.

In embodiments, functional code and test case analysis module 210 may be configured to generate at least one tree graph (i.e., a hierarchical graph, flowchart tree, process tree, and/or dependency tree) by converting a combination of the functional requirement flowchart and the test case flowchart into a tree graph. In such embodiments the functional requirement flowchart and the test case flowchart are combined by applying conditions of the conditions of the test case flowchart into steps of the functional requirement flowchart and then converting to a tree graph. For example, if a step in the functional requirement flowchart indicates an action that occurs after “several days” and if a corresponding step in the test case flowchart indicates that the action occurs after “seven days,” functional code and test case analysis module 210 will apply the condition when generating the tree graph, such that the action occurs after seven days. In embodiments, functional code and test case analysis module 210 may be configured to generate at least one tree graph by converting the functional requirement flowchart into a functional requirement tree graph and another tree graph by converting the test case flowchart into a tree graph. In such embodiments, the data related to the functional requirement flowchart and the test case flowchart are combined after the respective tree graphs are generated.

As used herein, tree graph refers to a hierarchical data structure that consists of nodes (i.e., vertices) connected by edges in a way that forms a tree-like structure. In embodiments the hierarchical structure of the tree graph may include properties such as: a root node which serves as the origin of the structure; parent-child nodes where each node (except the root) has one parent and may have multiple child nodes; and/or directed edges where the edges between nodes follow a direction. In embodiments, the directed edges may represent relationships between the nodes such as process flow, decision-making paths, and/or dependencies. In embodiments, converting the flowcharts into tree graphs beneficially standardizes the representation of functional requirements and test cases, enhances traceability between requirements and validation steps, facilitates automated comparison and defect detection, and enables structured analysis of decision-making paths and dependencies.

In embodiments, functional code and test case analysis module 210 may generate a normalized (i.e., standardized) test case by translating (i.e., converting, mapping, etc.) branches (i.e., paths) of the test case tree graph to related portions of a test template. In embodiments, each branch of the tree graph represents a sequence of actions and/or decisions in the functional workflow of the functional requirement document. In such embodiments, each branch is translated into a series of steps having a normalized format to ensure clarity and consistency. In embodiments, this occurs by identifying key elements in the tree graph, extracting branches from the tree graph, defining and/or obtaining a test template (i.e., test case template) based on the corresponding branches of the test case tree graph, and converting (i.e., translating, mapping, etc.) each branch into the test template. In embodiments, generating a normalized test case by translating the tree graphs into a template ensures consistency across test cases, enhances readability and interpretability, facilitates automated analysis and defect detection, and improves alignment for identifying potential test cases to discover defects in the functional requirement document.

Functional code and test case analysis module 210 may be configured to assign labels to the normalized test case to describe the respective portions of the normalized test case. In such embodiments, each portion of the normalized test case is assigned a label such as a noun, an action, a condition, an outcome, or any other label that describes the process and/or event occurring at each step. In embodiments, the assigned labels are labels selected from a group consisting of a noun, an action, and a condition.

In embodiments, functional code and test case analysis module 210 may be configured to assign an initial weight (i.e., weighting, regression coefficient, etc.). In such embodiments, higher weights are assigned to features that contribute more to similarity while lower weights are assigned to features that contribute less to similarity. In embodiments, the weights are assigned by a user in response to a prompt generated by functional code and test case analysis module 210. In other embodiments, functional code and test case analysis module 210.

In accordance with aspects of the present invention, defect analysis module 215 is configured to convert the known defect document into at least one defect flowchart. In embodiments the known defect document is converted into at least one flowchart by identifying specifications such as processes, user interactions, system behaviors, action sequences, decision points, and/or outputs. Based on the identified specifications, determine a sequence of actions which can be mapped into a start, inputs, processes, decisions, outputs, and end.

In embodiments, defect analysis module 215 may be configured to convert a defect flowchart into at least one tree graph. In embodiments, defect analysis module 215 may translate (i.e., convert) each branch of a defects tree branch into a test template (i.e. test case template) in the same (or similar) manner as is described above with respect to the test case tree graph.

In embodiments, defect analysis module 215 may generate normalized (i.e., standardized) defects cases by translating (i.e., converting, mapping, etc.) branches (i.e., paths) of the defects tree graphs to related portions of a test template. In such embodiments, each branch is translated into a series of steps having a normalized format to ensure clarity and consistency. In embodiments, this occurs by identifying key elements in the defects tree graph, extracting branches from the tree graph, defining and/or obtaining a test template (i.e., test case template) based on the corresponding branches of the defects tree graphs, and converting (i.e., translating, mapping, etc.) each branch into the test template.

Defect analysis module 215 may be configured to assign labels to the normalized defects cases to describe the respective portions of the normalized defects cases. In such embodiments, each portion of the normalized defects cases are assigned a label such as a noun, an action, a condition, an outcome, or any other label that describes the process and/or event occurring at each step. In embodiments, the labels assigned to the normalized test case (i.e., first labels) and the labels assigned to the normalized defects cases (i.e., second labels) are the same, meaning, the same labels are assigned to the same portions of the respective cases.

In embodiments, defect analysis module 215 may be configured to assign an initial weight (i.e., weighting, regression coefficient, etc.) to the normalized branches of the tree graphs. In such embodiments, higher weights are assigned to features that contribute more to similarity while lower weights are assigned to features that contribute less to similarity. In embodiments, the weights are assigned by a user in response to a prompt generated by defect analysis module 215.

In embodiments, defect detection and recommendation module 220 may build, train, and/or obtain a regression model (e.g., linear regression, polynomial regression, logistic regression, and/or any other regression model capable of predicting similarity scores) to predict and/or determine similarities between the normalized test case and at least one normalized defects case of the normalized defects based on the portions of the test template, the assigned labels, and the assigned weights.

In embodiments, the regression model may be iteratively trained (i.e., trained and retrained) on historical test case data, corresponding linked defects, and calculated weights (i.e. regression coefficients). In embodiments, the historical test case data and the corresponding linked defects may be obtained from a knowledge base and/or data repository (e.g., knowledge base 235). The trained model learns weights for each step of the test template by minimizing the error between predicted similarity scores and actual similarity scores from labeled data. In embodiments, the error may be minimized using a gradient descent technique and/or another optimization technique. In such embodiments, as noted above, higher weights are assigned to features that contribute more to similarity while lower weights are assigned to features that contribute less to similarity. In embodiments, a user may manipulate, approve, and/or enter weights to be used while training the regression model. In embodiments, a user only provides the initial weights, and the regression model adjusts and refines the weights to provide more accurate weights to determine similarities. Employing a regression model in this manner enhances the accuracy of similarity predictions, automates defect detection, reduces manual effort in test case analysis, and improves the reliability of test validation by continuously refining weight assignments based on historical data and real-world defect correlations in a manner that is well beyond what a human mind can perform with pen and paper.

In accordance with aspects of the present invention, defect detection and recommendation module 220 is configured to compare the normalized test case and at least one of the normalized defects cases by comparing the normalized text (e.g., text translated from a tree graph into a test template) of the flow charts associated with the respective test cases. In embodiments, this comparison is performed using a string matching algorithm (e.g., Levenshtein distance, Jaccard similarity, cosine similarity, and/or other string matching algorithms) to identify similarities between the descriptions in corresponding template groupings of the formatted functional requirement test case and formatted existing defect test case. In embodiments, the comparison is performed using natural language processing techniques (e.g., bidirectional encoder representations from transformers (BERT), sentence bidirectional encoder representations from transformers (S-BERT), and/or other sentence decoder models) to extract keywords and detect synonyms. In embodiments, defect detection and recommendation module 220 may assign labels based on the results of the comparison by analyzing determined similarities and the contextual relevance and providing a label describing the contextual relevance. Assigning labels allows the comparison process to categorize and interpret similarities more effectively, improve the precision of defect detection, enhance traceability between test cases and defects, and facilitate automated decision-making by providing context-aware insights.

In embodiments, defect detection and recommendation module 220 may determine and/or identify potential issues and potential solutions based on the similarities between the normalized test case and at least one normalized defects case of the normalized defects cases. For example, in embodiments, defect detection and recommendation module 220 may classify the relationship as being the same (e.g., the normalized test case is the same as the normalized defects case), as having a known defect (e.g., the normalized test case contains a known defect), as being part of a known defect (e.g., the normalized defects case contains the normalized test case), or that portions of normalized test case and the normalized defects cases may be related.

In embodiments defect detection and recommendation module 220 may provide solutions, workarounds, and/or other commentary regarding potential defects to a user. In embodiments, other comments may include risk assessments (i.e., how critical a potential defect may be and its possible impact on the system), suggested test enhancements (i.e., recommendations for modifying and/or adding test cases to cover potential edge cases), root cause analysis (i.e., insights into why the defect may occur and whether it stems from design, implementation, and/or integration issues), dependency warnings (i.e., alerts regarding related modules, features, and/or third-party services that might be affected by the defect), regression risks (i.e., warnings if fixing and/or addressing the defect might introduce new problems elsewhere in the system), recommended development changes (i.e., suggestions for altering the functional design to prevent similar defects in the future), and more.

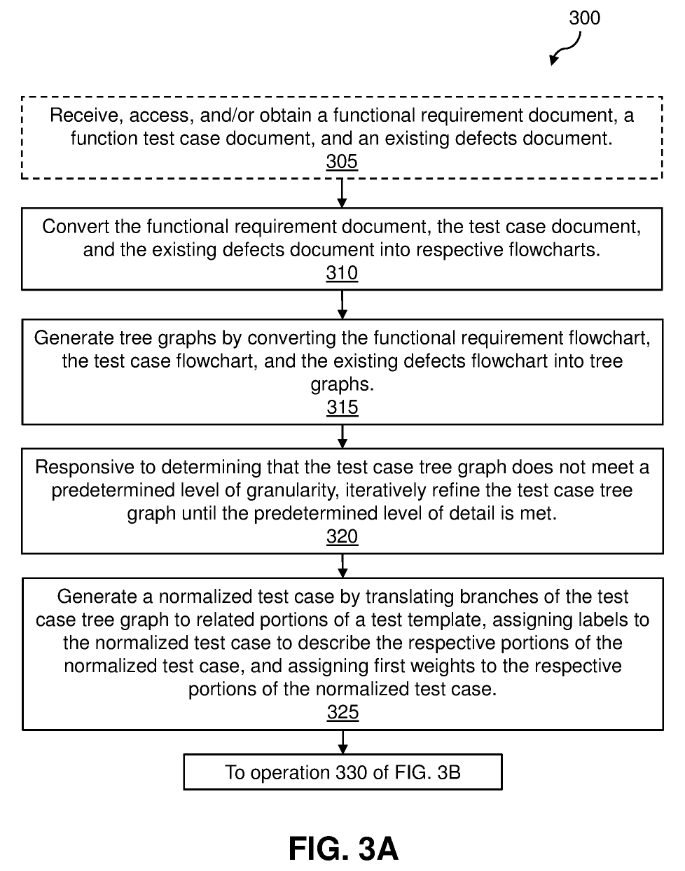

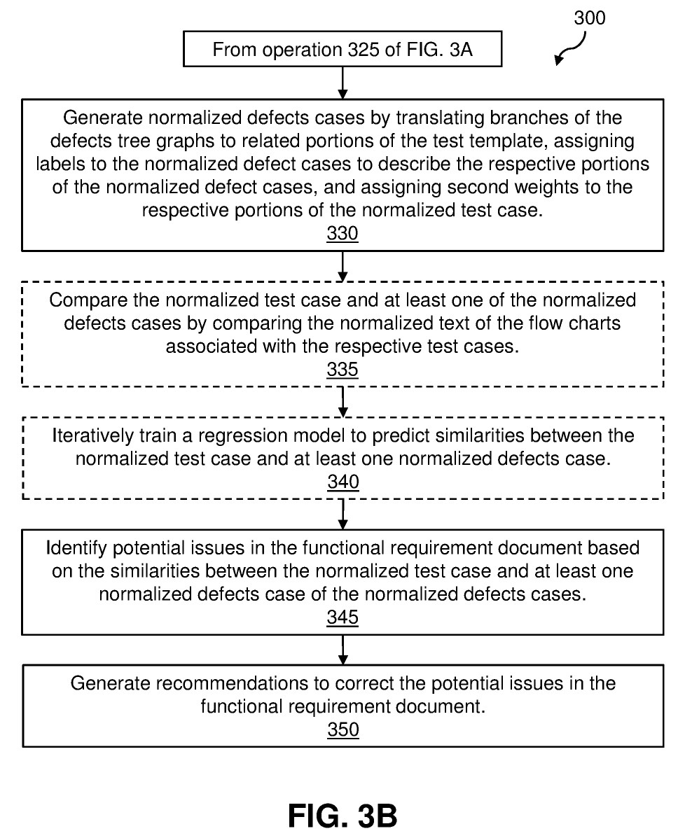

FIGS. 3A-3B show a flow diagram of an exemplary method 300 in accordance with aspects of the present invention. Operations of the method 300 are described with reference to elements and actions depicted in and described with reference to FIG. 2.

At operation 305, the system (e.g., defect detection server 205 of FIG. 2) is optionally configured (as indicated by the dotted line) to receive, access, and/or obtain a functional requirement document, a function test case document, and an existing defects document. In embodiments, respective documents may be received, accessed, and/or obtained from a data source (e.g., data source 230), a knowledge base (e.g., knowledge base 235) and/or a user device (e.g., user device 240). Operation 305 may be performed in accordance with the descriptions and embodiments of defect detection server 205 of FIG. 2.

At operation 310, the system (e.g., functional code and test case analysis module 210 and defect analysis module 215 of FIG. 2) is configured to convert the functional requirement document, the test case document, and the existing defects document into respective flowcharts. In embodiments, operation 310 may be performed in accordance with the descriptions and embodiments of functional code and test case analysis module 210 and defect analysis module 215 of FIG. 2.

At operation 320, the system (e.g., functional code and test case analysis module 210 of FIG. 2) is configured to, responsive to determining that the test case tree graph does not meet a predetermined level of granularity, iteratively refine the test case tree graph until the predetermined level of detail is met. In embodiments, the test cast tree graph is refined iteratively until it meets a predetermined level of granularity by identifying ambiguous details (e.g., determining whether the tree graph lacks specificity in actions, conditions, and/or expected outcome or has vague descriptions, generalized statements, and/or missing decision points), by expanding nodes with insufficient granularity (e.g., breaking actions, conditions, and/or decisions into finer, more granular, steps), and/or by receiving iterative feedback (e.g., user and/or automated process may approve and/or further refine the graph based on domain expertise). Operation 320 may be performed in accordance with the descriptions and embodiments of functional code and test case analysis module 210 of FIG. 2.

At operation 315, the system (e.g., functional code and test case analysis module 210 and defect analysis module 215 of FIG. 2) is configured to generate tree graphs by converting the functional requirement flowchart, the test case flowchart, and the existing defects flowchart into respective tree graphs (e.g., a functional requirement tree graph, a test case tree graph, and/or a defects tree graph). Operation 315 may be performed in accordance with the descriptions and embodiments of functional code and test case analysis module 210 and defect analysis module 215 of FIG. 2.

At operation 325, the system (e.g., functional code and test case analysis module 210 of FIG. 2) is configured to generate a normalized test case by translating branches of the test case tree graph to related portions of a test template, assigning labels to the normalized test case to describe the respective portions of the normalized test case, and assigning first weights to the respective portions of the normalized test case. Operation 325 may be performed in accordance with the description and embodiments of functional code and test case analysis module 210 of FIG. 2.

At operation 330, the system (e.g., defect analysis module 215 of FIG. 2) is configured to generate normalized defects cases by translating branches of the existing defects flowchart to related portions of the test template, assigning labels to the normalized defects cases to describe the respective portions of the normalized defects cases, and assigning second weights to the respective portions of the normalized test case. Operation 330 may be performed in accordance with the description and embodiments of defect analysis module 215 of FIG. 2. In embodiments, the assigned first and second weights may be the same.

At operation 335, the system (e.g., defect detection and recommendation module 220 of FIG. 2) is optionally configured to compare the normalized test case and at least one of the normalized defects cases by comparing the normalized text of the flow charts associated with the respective test cases. In embodiments, this comparison is performed using a string matching algorithm (e.g., Levenshtein distance, Jaccard similarity, cosine similarity, and/or other string matching algorithms) to identify similarities between the descriptions in corresponding template groupings of the formatted functional requirement test case and formatted existing defect test case. In embodiments, the comparison is performed using natural language processing techniques (e.g., bidirectional encoder representations from transformers (BERT), sentence bidirectional encoder representations from transformers (S-BERT), and/or other sentence decoder models) to extract keywords and detect synonyms. Operation 335 may be performed in accordance with the description and embodiments of defect detection and recommendation module 220 of FIG. 2.

At operation 340, the system (e.g., defect detection and recommendation module 220 of FIG. 2) is optionally configured to iteratively train a regression model to predict similarities between the normalized test case and at least one of the normalized defects cases. In embodiments, the regression model may be iteratively trained (i.e., trained and retrained) on historical test case data, corresponding linked defects, and calculated weights (i.e. regression coefficients). In embodiments, the historical test case data and the corresponding linked defects may be obtained from a knowledge base and/or data repository (e.g., knowledge base 235 of FIG. 2). Operation 340 may be performed in accordance with the description and embodiments of defect detection and recommendation module 220 of FIG. 2.

At operation 345, the system (e.g., defect detection and recommendation module 220 of FIG. 2) is configured to identify potential issues in the functional requirement document based on the similarities between the normalized test case and at least one of the normalized defects cases. Operation 335 may be performed in accordance with the description and embodiments of defect detection and recommendation module 220 of FIG. 2.

At operation 350, the system (e.g., defect detection and recommendation module 220 of FIG. 2) is configured to generate recommendations to correct the potential issues in the functional requirement document. As noted above, defect detection and recommendation module 220 may also provide solutions, workarounds, and/or other commentary regarding potential defects to a user. In embodiments, other comments may include risk assessments (i.e., how critical a potential defect may be and its possible impact on the system), suggested test enhancements (i.e., recommendations for modifying and/or adding test cases to cover potential edge cases), root cause analysis (i.e., insights into why the defect may occur and whether it stems from design, implementation, and/or integration issues), dependency warnings (i.e., alerts regarding related modules, features, and/or third-party services that might be affected by the defect), regression risks (i.e., warnings if fixing and/or addressing the defect might introduce new problems elsewhere in the system), recommended development changes (i.e., suggestions for altering the functional design to prevent similar defects in the future), and more. Operation 350 may be performed in accordance with the description and embodiments of defect detection and recommendation module 220 of FIG. 2.

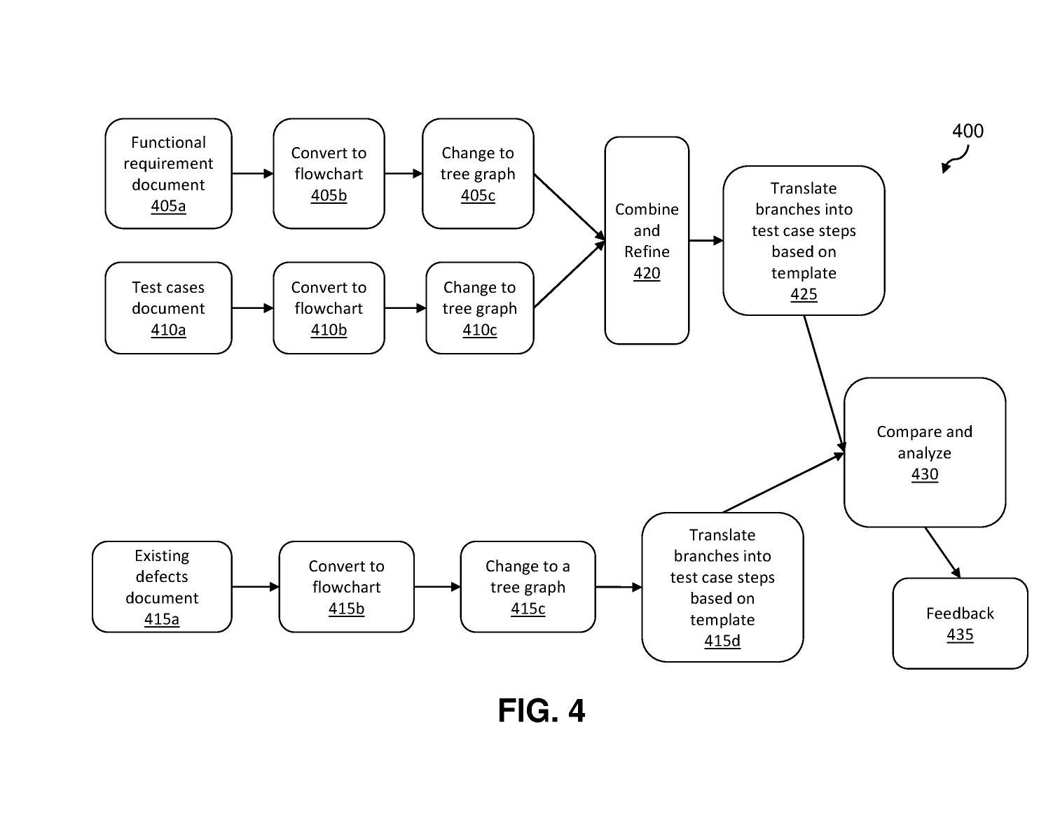

FIG. 4 shows a flow diagram of an exemplary method 400 in accordance with aspects of the present invention. Operations of the method 400 are described with reference to elements and actions depicted in and described with reference to FIGS. 2 and 3.

At operations 405a, 410a, and 415a defect detection server 205 of FIG. 2 is configured to receive, obtain, and/or access a functional requirement document at operation 405a, a test cases document at operation 410a, and an existing defects document at operation 415a. In embodiments, operation 405a, 410a, and 415a be carried out in accordance with operation 305 of FIG. 3A and/or in accordance with the descriptions and embodiments of defect detection server 205 of FIG. 2.

At operations 405b and 405c, functional code and test case analysis module 210 of FIG. 2 is configured to convert the functional requirement document into a flowchart format at operation 405b and change the flowchart into a tree graph at operation 405c. In embodiments, operation 405b and 405c may be carried out in accordance with operations 310-315 of FIG. 3A and/or in accordance with the descriptions and embodiments of functional code and test case analysis module 210 of FIG. 2.

Similarly, at operations 410b and 410c, functional code and test case analysis module 210 of FIG. 2 is configured to convert the test cases document into a flowchart format at operation 410b and change the flowchart into a tree graph at operation 410c. In embodiments, operation 410b and 410-c may be carried out in accordance with operations 310-315 of FIG. 3A and/or in accordance with the descriptions and embodiments of functional code and test case analysis module 210 of FIG. 2.

At operations 415b and 415c, defect analysis module 215 of FIG. 2 is configured to convert the existing defects document into a flowchart format at operation 415b and change the flowchart into a tree graph at operation 415c. In embodiments, operation 415b and 415c may be carried out in accordance with operations 310-315 of FIG. 3A and/or in accordance with the descriptions and embodiments of defect analysis module 215 of FIG. 2.

At operation 420, functional code and test case analysis module 210 is configured to combine the functional requirement tree graph with the test case tree graph to create a combined tree graph. In embodiments, the functional requirement tree graph and the test case tree graph are combined by applying conditions of test case tree graph into steps of the functional requirement tree graph and then converting to a combined tree graph. For example, if a step in the functional requirement tree graph indicates an action that occurs after “several days” and if a corresponding step in the test case tree graph indicates that the action occurs after “seven days,” functional code and test case analysis module 210 will apply the condition when generating the combined tree graph, such that the indicated action occurs after seven days. In embodiments, the data related to the functional requirement tree graph and the test case tree graph may be combined before the respective tree graphs are generated. In such embodiments, functional code and test case analysis module 210 would skip operations 405c and 410c, and would instead generate a combined tree graph based on the flowcharts. In embodiments, operation 420 may be carried out in accordance with operations 315-320 of FIG. 3A and/or in accordance with the descriptions and embodiments of functional code and test case analysis module 210 of FIG. 2.

At operation 425, functional code and test case analysis module 210 is configured to translate branches of the combined tree graph into test case steps based on a test case template. As noted above, each branch of the tree graph represents a sequence of actions and/or decisions in the functional workflow of the functional requirement document. In such embodiments, each branch is translated into a series of steps having a normalized format to ensure clarity and consistency. In embodiments, this occurs by identifying key elements in the tree graph, extracting branches from the tree graph, defining and/or obtaining a test template (i.e., test case template) based on the corresponding branches of the test case tree graph, and converting (i.e., translating, mapping, etc.) each branch into the test template. In embodiments, operation 425 may be carried out in accordance with operation 325 of FIG. 3A and/or in accordance with the descriptions and embodiments of functional code and test case analysis module 210 of FIG. 2.

At operation 415d, defect analysis module 215 is configured to translate branches of the defects tree graph into test case steps based on a test case template using the same, or similar, methods as operation 425. In embodiments, operation 415d may be carried out in accordance with operation 330 of FIG. 3B and/or in accordance with the descriptions and embodiments of defect analysis module 215 of FIG. 2.

At operation 430, defect detection and recommendation module 220 is configured to compare and analyze the test case steps (i.e., normalized test case) generated at operation 425 against the test case steps (i.e., normalized defects case) generated at operation 415d. In embodiments defect detection and recommendation module 220 may build, train, and/or obtain a regression model (e.g., linear regression, polynomial regression, logistic regression, and/or any other regression model capable of predicting similarity scores) to predict and/or determine similarities between the test case steps generated at operation 425 and the test case steps generated at operation 415d, based on the portions of the test template, the assigned labels, and the assigned first and second weights. In embodiments, defect detection and recommendation module 220 may be further configured to compare the normalized test case and at least one of the normalized defects cases by comparing the normalized text (e.g., text translated from a tree graph into a test template) of the flow charts associated with the respective test cases. In embodiments, operation 430 may be carried out in accordance with operations 335-345 of FIG. 3B and/or in accordance with the descriptions and embodiments of defect detection and recommendation module 220 of FIG. 2.

At operation 435, defect detection and recommendation module 220 is configured to provide feedback to developers. In embodiments, defect detection and recommendation module 220 may determine and/or identify potential issues and potential solutions based on the similarities between the normalized test case and at least one normalized defects case of the normalized defects cases. In embodiments, other comments may include risk assessments, suggested test enhancements, root cause analysis, dependency warnings, regression, recommended development changes, and more. In embodiments, operation 430 may be carried out in accordance with operations 345-350 of FIG. 3B and/or in accordance with the descriptions and embodiments of defect detection and recommendation module 220 of FIG. 2.

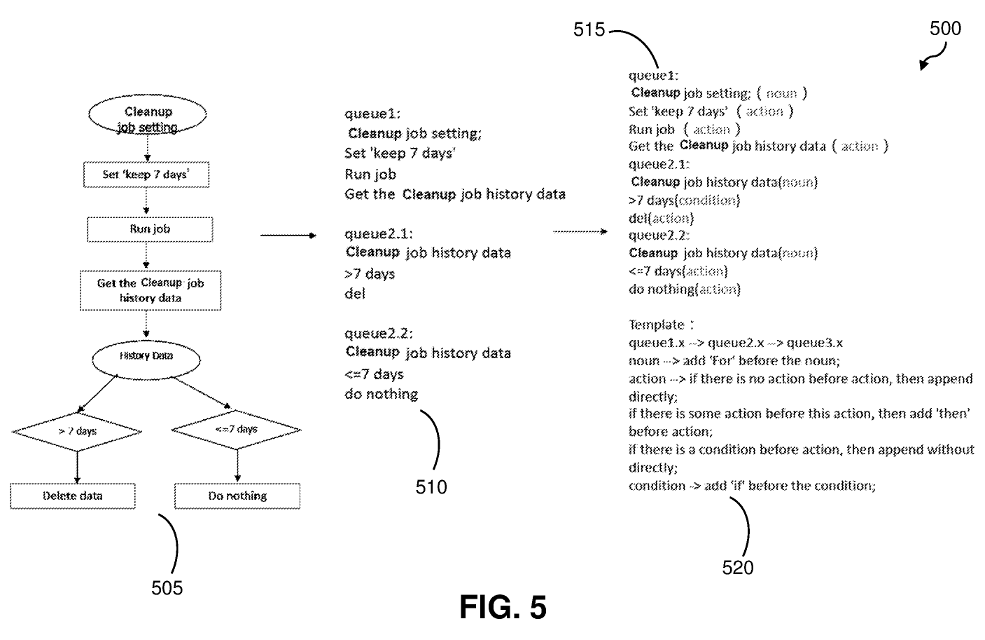

FIG. 5 shows a flowchart of an exemplary method 500 in accordance with aspects of the present invention. Operations of the method 500 are described with reference to elements and actions depicted in and described with reference to FIGS. 2 and 3.

Operation 505 depicts an exemplary tree graph describing nouns, actions, and conditions for implementing a cleanup job setting operation configured to delete historical data that is more than 7 days old. In embodiments, operation 505 may be carried out in accordance with operations 315-320 of FIG. 3A and/or in accordance with the descriptions and embodiments of functional code and test case analysis module 210 of FIG. 2

Operation 510 depicts exemplary text in the process of being translated into a test case template 520. As shown, the system (e.g., functional code and test case analysis module 210 of FIG. 2) separates the branches of the tree graph into queue 1, queue 2.1, and queue 2.2 so that each branch of the tree graph can be further processed as a single (i.e., separate, unique, etc.) functionality and so that the data can be more easily normalized. In embodiments, operation 510 may be carried out in accordance with operation 325 of FIG. 3A and/or in accordance with the descriptions and embodiments of functional code and test case analysis module 210 of FIG. 2.

Operation 515 depicts exemplary text in the process of being translated into a test case template 520. As shown, the system (e.g., functional code and test case analysis module 210 of FIG. 2) applies labels to nouns, actions, and conditions of the cleanup job setting operation, based on the operation and/or functionality of those features. Assigning labels allows the comparison process to categorize and interpret similarities more effectively, improve the precision of defect detection, enhance traceability between test cases and defects, and facilitate automated decision-making by providing context-aware insights. In embodiments, operation 515 may be carried out in accordance with operation 325 of FIG. 3A and/or in accordance with the descriptions and embodiments of functional code and test case analysis module 210 of FIG. 2.

Test case template 520 depicts a finalized (or nearly finalized) test case for the exemplary cleanup job setting operation. In embodiments, test case template 520 is prepared for comparing it against known defects cases that have been similarly processed, to identify issues, solutions, and recommendations, previously unknown and/or overlooked by developers, for improving the functional documents. In embodiments, test case template 520 may be prepared in accordance with operation 325 of FIG. 3A and/or in accordance with the descriptions and embodiments of functional code and test case analysis module 210 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating a test case tree graph based on a combination of a functional requirement document and a test case document;
generating a plurality of defects tree graphs based on a known defects document;
responsive to determining that the test case tree graph does not meet a predetermined level of granularity, iteratively refining the test case tree graph until the predetermined level of granularity is met;
generating a normalized test case by translating branches of the test case tree graph to related portions of a test template, assigning first labels to the normalized test case to describe the respective portions of the normalized test case, and assigning first weights to the respective portions of the normalized test case;
generating normalized defects cases by translating branches of the defects tree graphs to related portions of the test template, assigning second labels to the normalized defects cases to describe the respective portions of the normalized defects cases, and assigning second weights to the respective portions of the normalized test case; and
generating recommendations to correct potential issues in the functional requirement document identified based on similarities between the normalized test case and one or more respective ones of the normalized defects cases.

2. The method of claim 1, further comprising receiving the functional requirement document, the test case document, and the known defects document from a data source.

3. The method of claim 1, further comprising iteratively training a regression model to predict similarities between the normalized test case and the one or more respective ones of the normalized defects cases based on the portions of the test template, the assigned first and second labels, and the assigned first and second weights.

4. The method of claim 1, further comprising identifying potential issues in the functional requirement document based on the similarities between the normalized test case and the one or more respective ones of the normalized defects cases.

5. The method of claim 1, further comprising converting the functional requirement document into a functional requirement flowchart and the test case document into a test case flowchart, wherein the generating a test case tree graph if further based on the functional requirement flowchart and the test case flowchart.

6. The method of claim 5, wherein the generating a test case tree graph comprises applying conditions of the test case document into steps of the functional requirement document.

7. The method of claim 5, wherein the converting the functional requirement document into a functional requirement flowchart is performed using natural language processing.

8. The method of claim 1, wherein the first weights comprise regression model coefficients for each of the respective portions of the normalized test case based on a level of contribution of each portion for determining a similarity relationship.

9. The method of claim 1, wherein the assigned labels are labels selected from a group consisting of: a noun, an action, and a condition.

10. The method of claim 1, wherein the recommendation comprises a test enhancement to cover a potential edge case.

11. A computer program product comprising:
one or more computer-readable storage media; and
program instructions stored on the one or more computer-readable storage media to perform operations comprising:
generating a test case tree graph based on a combination of a functional requirement document and a test case document;
generating a plurality of defects tree graphs based on a known defects document;
responsive to determining that the test case tree graph does not meet a predetermined level of granularity, iteratively refining the test case tree graph until the predetermined level of granularity is met;
generating a normalized test case by translating branches of the test case tree graph to related portions of a test template, assigning first labels to the normalized test case to describe the respective portions of the normalized test case, and assigning first weights to the respective portions of the normalized test case;
generating normalized defects cases by translating branches of the defects tree graphs to related portions of the test template, assigning second labels to the normalized defects cases to describe the respective portions of the normalized defects cases, and assigning second weights to the respective portions of the normalized test case; and
generating recommendations to correct potential issues in the functional requirement document identified based on similarities between the normalized test case and one or more respective ones of the normalized defects cases.

12. The computer program product of claim 11, wherein the operations further comprise iteratively training a regression model to predict similarities between the normalized test case and the one or more respective ones of the normalized defects cases based on the portions of the test template, the assigned first and second labels, and the assigned first and second weights.

13. The computer program product of claim 11, wherein the operations further comprise identifying potential issues in the functional requirement document based on the similarities between the normalized test case and the one or more respective ones of the normalized defects cases.

14. The computer program product of claim 11, wherein the operations further comprise converting the functional requirement document into a functional requirement flowchart and the test case document into a test case flowchart, wherein the generating a test case tree graph if further based on the functional requirement flowchart and the test case flowchart.

15. The computer program product of claim 11, wherein the assigned labels are labels selected from a group consisting of: a noun, an action, and a condition.

16. The computer program product of claim 11, wherein the recommendation comprises a regression risk.

17. A computer system comprising:
a processor set;
one or more computer-readable storage media; and
program instructions stored on the one or more computer-readable storage media to cause the processor set to perform operations comprising:
generating a test case tree graph based on a combination of a functional requirement document and a test case document;
generating a plurality of defects tree graphs based on a known defects document;
responsive to determining that the test case tree graph does not meet a predetermined level of granularity, iteratively refining the test case tree graph until the predetermined level of granularity is met;
generating a normalized test case by translating branches of the test case tree graph to related portions of a test template, assigning first labels to the normalized test case to describe the respective portions of the normalized test case, and assigning first weights to the respective portions of the normalized test case;
generating normalized defects cases by translating branches of the defects tree graphs to related portions of the test template, assigning second labels to the normalized defects cases to describe the respective portions of the normalized defects cases, and assigning second weights to the respective portions of the normalized test case; and
generating recommendations to correct potential issues in the functional requirement document identified based on similarities between the normalized test case and one or more respective ones of the normalized defects cases.

18. The computer system of claim 17, wherein the operations further comprise iteratively training a regression model to predict similarities between the normalized test case and the one or more respective ones of the normalized defects cases based on the portions of the test template, the assigned first and second labels, and the assigned first and second weights.

19. The computer system of claim 17, wherein the operations further comprise identifying potential issues in the functional requirement document based on the similarities between the normalized test case and the one or more respective ones of the normalized defects cases.

20. The computer system of claim 17, wherein the operations further comprise converting the functional requirement document into a functional requirement flowchart and the test case document into a test case flowchart, wherein the generating a test case tree graph if further based on the functional requirement flowchart and the test case flowchart.
